(19) United States
(12) Patent Application Publication
(10) Pub. No.: US 2017/0293071 A1
(43) Pub. Date: Oct. 12, 2017

(54) PLANAR LIGHTING DEVICE

(71) Applicant: MINEBEA MITSUMI INC., Kitasaku-gun (JP)

(72) Inventors: Shohei TAKADA, Hamamatsu (JP); Hideyuki TOKUNAGA, Fukuroi (JP)

(73) Assignee: MINEBEA MITSUMI INC., Kitasaku-gun (JP)

(21) Appl. No.: 15/468,531

(22) Filed: Mar. 24, 2017

(30) Foreign Application Priority Data
Apr. 8, 2016 (JP) 2016-078323

(51) Int. Cl. F21V 8/00

(52) U.S. Cl. CPC G02B 6/0081; G02B 6/0055; G02B 6/0073

(57) ABSTRACT

A planar lighting device according to an embodiment includes: a light guide that has flexibility and receives light from a side surface and emits the light from a light-emitting surface; a light source disposed close to the side surface and emits light that enters the side surface; a first frame having a curved shape and having an aperture; a second frame having a curved surface for sandwiching the light guide between the first frame and the curved surface such that the light-emitting surface faces the aperture; and an optical sheet disposed close to the light-emitting surface with at least a part of an edge portion of the optical sheet being disposed in a space defined by the first frame and the light guide, the part being separated from the first frame.

### CROSS-REFERENCE TO RELATED APPLICATION(S)

The present application claims priority to and incorporates by reference the entire contents of Japanese Patent Application No. 2016-078323 filed in Japan on Apr. 8, 2016.

### BACKGROUND OF THE INVENTION

### 1. Field of the Invention

The present invention relates to a planar lighting device.

### 2. Description of the Related Art

Planar lighting devices used in a curved state are known. Such planar lighting devices include, for example, a flexible light guide, a flexible lens sheet, and a frame that houses the light guide and the lens sheet in a curved state. Conventional technologies are described in Japanese Laid-open Patent Publication No. 2010-140831 and Japanese Laid-open Patent Publication No. 2014-122973, for example.

When such a planar lighting device is installed in, for example, a vehicle, the planar lighting device will be used in a wide range of temperature conditions from −40° C. to +95° C. When the temperature of a working environment of the planar lighting device is high such as around 95° C., for example, an optical sheet may be corrugated or distorted, or have an undulating shape due to thermal expansion. Such a corrugated optical sheet may cause an unacceptable brightness variation on a screen of a liquid crystal display device using the planar lighting device as a backlight.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an example of an external appearance of a planar lighting device according to an embodiment of the present invention;

FIG. 2 is a diagram illustrating a first step of a method for manufacturing the planar lighting device according to the embodiment;

FIG. 3 is a diagram illustrating the first step of the method for manufacturing the planar lighting device according to the embodiment;

FIG. 4 is a diagram illustrating a second step of the method for manufacturing the planar lighting device according to the embodiment;

FIG. 5 is a diagram illustrating the second step of the method for manufacturing the planar lighting device according to the embodiment;

FIG. 6 is a diagram illustrating the second step of the method for manufacturing the planar lighting device according to the embodiment;

FIG. 7 is a diagram illustrating a change in form of a light guide;

FIG. 8 is a diagram illustrating a third step of the method for manufacturing the planar lighting device according to the embodiment;

FIG. 9 is an enlarged view of a part of an upper frame illustrated in FIG. 8;

FIG. 10 is a cross-sectional view of the planar lighting device assembled such that the upper frame and a lower frame are joined together and a lighting module is sandwiched between the upper and the lower frames;

FIG. 11 is an enlarged view illustrating a part of the planar lighting device illustrated in FIG. 10;

FIG. 12 is an enlarged view illustrating a part of the planar lighting device illustrated in FIG. 10;

FIG. 13 is a perspective view illustrating the upper frame and the lower frame joined together in the third step;

FIG. 14 is an enlarged view of a part of the lower frame illustrated in FIG. 13;

FIG. 15 is a perspective view illustrating another example of the upper frame and the lower frame joined together in the third step;

FIG. 16 is a diagram illustrating another example of the planar lighting device; and

FIG. 17 is a diagram illustrating still another example of the planar lighting device.

### DETAILED DESCRIPTION OF THE PREFERRED EMBODIMENT

A planar lighting device according to an embodiment of the present invention will be described below with reference to the accompanying drawings.

### Embodiment

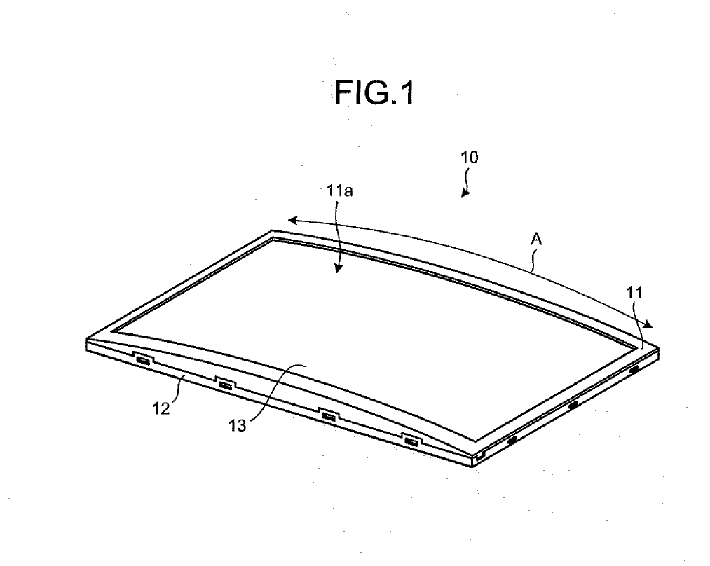

FIG. 1 is a perspective view illustrating an example of an external appearance of the planar lighting device according to the embodiment. As illustrated in FIG. 1, this planar lighting device 10 according to the embodiment includes an upper frame 11, a lower frame 12, and an optical sheet 13. The upper frame 11 is located at the upper side and the lower frame 12 is located at the lower side of the planar lighting device 10 when the planar lighting device 10 is laid flat.

The upper frame 11 has an aperture 11a. The upper frame 11 has a curved shape. The upper frame 11 is an example of a first frame. Light emitted from the optical sheet 13 passes through the aperture 11a to illuminate a liquid crystal display device, which is not illustrated. In other words, the planar lighting device 10 is used as a backlight of the liquid crystal display device. The optical sheet 13 is a laminate of a plurality of types of optical sheets. In the present embodiment, the optical sheet 13 is composed of three types of optical sheets 13a, 13b, and 13c that are laminated in this order, which are not illustrated in FIG. 1.

The planar lighting device 10 is curved in a direction of the longer dimension thereof, that is, in the longitudinal direction indicated by an arrow A. In other words, the upper frame 11, the lower frame 12, and the optical sheet 13 are curved in the direction of the respective longer dimensions. In the example of FIG. 1, the planar lighting device 10 has a shape of, what is called, a convex curve.

When, for example, a liquid crystal display device is used for an onboard navigation system installed in a vehicle, the liquid crystal display device needs to be shaped in conformance with a curved surface of the dashboard. Thus, the light-emitting surface of the planar lighting device that emits light to the liquid crystal display device also needs to have such a curved shape. The planar lighting device 10 according to the present embodiment, which has a curved shape, is suitable for use as a backlight of the liquid crystal display device in the onboard navigation system installed in a vehicle.

Described next is a method for manufacturing the planar lighting device 10.

First Step

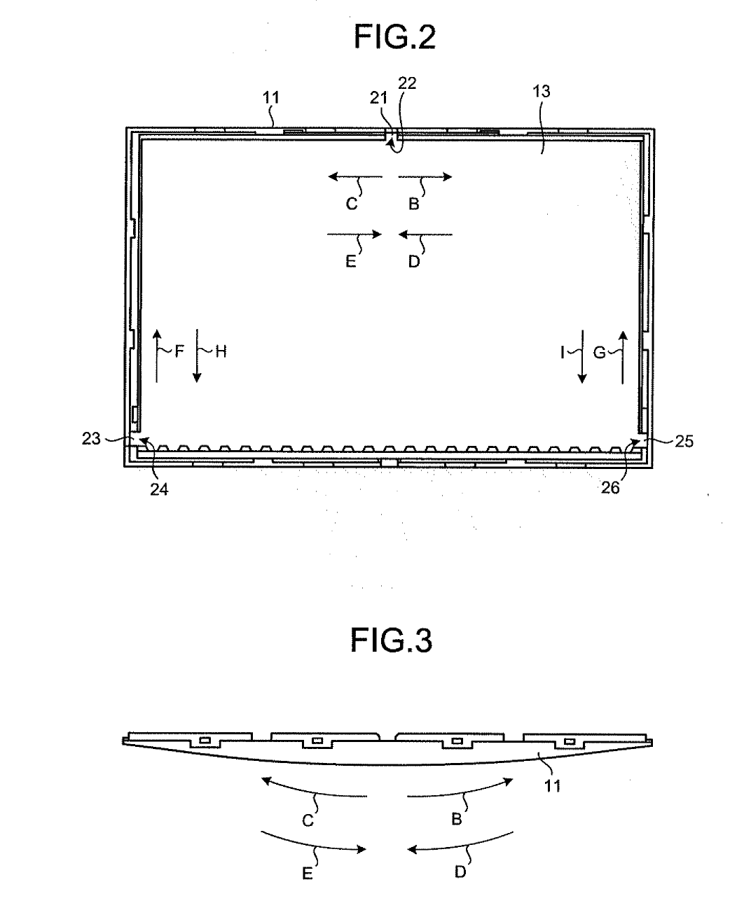

A first step of the method for manufacturing the planar lighting device 10 is described. In the first step, the optical sheet 13 is positioned relative to the upper frame 11 and is fixed thereto. The optical sheet 13 may be firmly fixed to the upper frame 11, or may be loosely fixed to the upper frame 11, that is, the optical sheet 13 is held such that it can move within a certain range of the upper frame 11. This is applicable to other components below that are held in a fixed state. FIGS. 2 and 3 are diagrams illustrating the first step of the method for manufacturing the planar lighting device 10 according to the embodiment. As illustrated in the example of FIG. 2, the optical sheet 13 has, for example, a protruding portion 21 disposed in a middle portion of the optical sheet 13 in the direction of the longer dimension. The protruding portion 21 protrudes in a direction orthogonal to the direction of the longer dimension of the optical sheet 13.

As illustrated in the example of FIG. 2, the upper frame 11 has a recessed portion 22 disposed in a middle portion of the upper frame 11 in the direction of the longer dimension. In the present embodiment, the protruding portion 21 can be engaged with the recessed portion 22. The protruding portion 21 of the optical sheet 13 is engaged with the recessed portion 22 of the upper frame 11, whereby the optical sheet 13 is positioned relative to the upper frame 11 in the direction of the longer dimension thereof and is fixed thereto.

As illustrated in the example of FIG. 2, the optical sheet 13 has protruding portions 23 and 25 disposed in side portions of the optical sheet 13 close to light emitting diodes (LEDs) 30 described later in the direction of the shorter dimension (transverse direction) of the optical sheet 13. The protruding portions 23 and 25 protrude in the direction of the longer dimension of the optical sheet 13.

As illustrated in the example of FIG. 2, the upper frame 11 has recessed portions 24 and 26 disposed in side portions of the upper frame 11 close to the LEDs 30 in the direction of the shorter dimension. In the present embodiment, the protruding portion 23 can be engaged with the recessed portion 24, and the protruding portion 25 can be engaged with the recessed portion 26. The protruding portion 23 of the optical sheet 13 is engaged with the recessed portion 24 of the upper frame 11, and the protruding portion 25 of the optical sheet 13 is engaged with the recessed portion 26 of the upper frame 11, whereby the optical sheet 13 is positioned relative to the upper frame 11 in the direction of the shorter dimension and is fixed thereto.

When the optical sheet 13, which is positioned and fixed as described above, is used in a high temperature condition, the optical sheet 13 expands in directions (indicated by arrows B and C) from the center of the optical sheet 13 to both sides thereof in the direction of the longer dimension as illustrated in the examples of FIGS. 2 and 3. When the optical sheet 13 is used in a low temperature condition, the optical sheet 13 shrinks in directions (indicated by arrows D and E) from the sides to the center of the optical sheet 13 in the direction of the longer dimension.

When the optical sheet 13 is used in a high temperature condition, the optical sheet 13 expands in a direction (indicated by an arrow F) from the protruding portion 23 to a side away from the LEDs 30 and expands in a direction (indicated by an arrow G) from the protruding portion 25 to the side away from the LEDs 30 with respect to the direction of the shorter dimension of the optical sheet 13. When the optical sheet 13 is used in a low temperature condition, the optical sheet 13 shrinks in a direction (indicated by an arrow H) from the side away from the LEDs 30 to the protruding portion 23 and shrinks in a direction (indicated by an arrow I) from the side away from the LEDs 30 to the protruding portion 25 with respect to the direction of the shorter dimension of the optical sheet 13.

The optical sheet 13, which is positioned and fixed relative to the direction of the longer dimension and to the direction of the shorter dimension, is curved in conformance with the curved shape of the upper frame 11.

Second Step

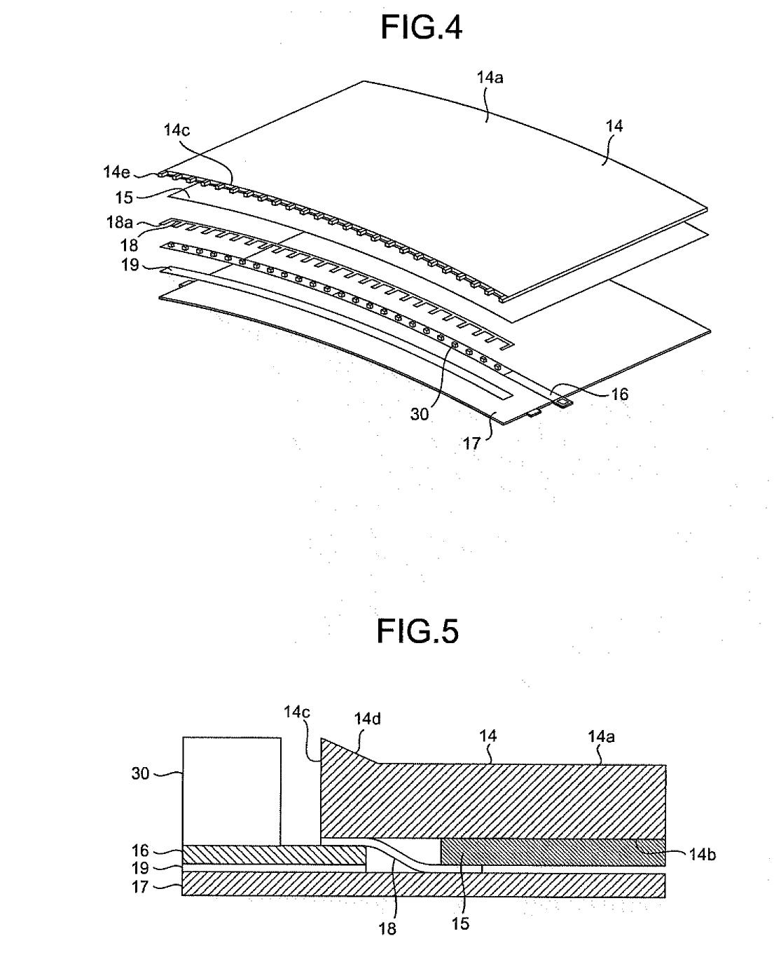

FIGS. 4, 5, and 6 are diagrams illustrating a second step of the method for manufacturing the planar lighting device 10 according to the embodiment. The second step is described with reference to FIGS. 4, 5, and 6. In the second step after the first step, a light guide 14, a reflector 15, a flexible printed circuit (FPC) 16, and a sheet metal 17 are integrated and fixed by using double-sided adhesive tapes 18 and 19. The LEDs 30 are mounted on the FPC 16.

The light guide 14, the reflector 15, the FPC 16, the sheet metal 17, and the LEDs 30 are described first, and the procedure of the second step is described later. The LEDs 30 are light sources each having a point-like form (point-like light sources). The LEDs 30 are pseudo-white LEDs composed of, for example, blue LEDs and yellow phosphor. The LEDs 30 each have a substantially rectangular parallelepiped shape having a light-emitting surface on one side, which is what is called a side-view LED. In other words, a surface of the LEDs 30 in contact with the FPC 16 is substantially perpendicular to the light-emitting surface of the LEDs 30. The LEDs 30 are mounted on the FPC 16 in the direction of the longer dimension of the FPC 16 with a certain gap left therebetween and with the light-emitting surface facing in the direction of the shorter dimension of the FPC 16. Thus, the LEDs 30 in the finished planar lighting device 10 are arranged such that the light-emitting surface of the LEDs 30 faces a light-receiving side surface 14c of the light guide 14 described later and arranged in the direction of the longer dimension of the light-receiving side surface 14c with a certain gap left therebetween.

The light guide 14 is made of a transparent material (such as a polycarbonate resin) and has a rectangular shape when seen from above. The light guide 14 has flexibility and changes its shape by external force. The light guide 14 has outer surfaces including two major surfaces 14a and 14b and the light-receiving side surface 14c to be located close to the LEDs 30. The major surface 14a is the light-emitting surface from which light emitted by the LEDs 30 and received through the light-receiving side surface 14c is emitted. Thus, the major surface 14a may be referred to as a light-emitting surface 14a in the following description. The major surface 14b of the light guide 14 is formed with, for example, a light redirecting pattern drawn with a plurality of dots. Such a light redirecting pattern changes directions of the light traveling in the light guide 14, and the light is emitted from the light-emitting surface 14a. The shorter dimension of the light-receiving side surface 14c is equal to or little larger than the dimension of the light-emitting surface of the LEDs 30 in the corresponding direction. The light-receiving side surface 14c receives light emitted from the LEDs 30.

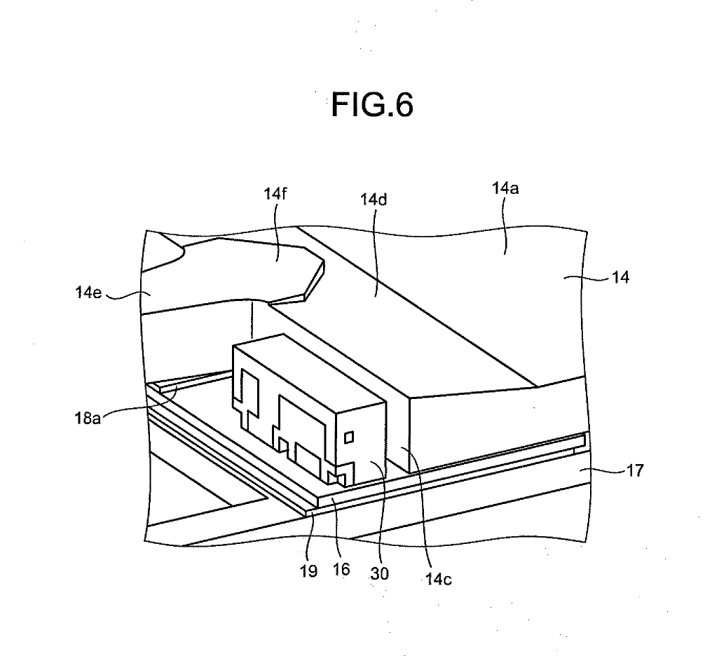

The light guide 14 has a sloping portion 14d (see FIGS. 5 and 6), claw portions 14e (see FIGS. 4 and 6), and pedestal portions 14f (see FIG. 6). The sloping portion 14d slopes such that the light guide 14 becomes less thick as the sloping portion 14d extends from the light-receiving side surface 14c in the direction toward the opposite side surface, that is, the direction in which the received light travels. The claw portions 14e protrude from the light-receiving side surface 14c and are separately arranged in the direction of the longer dimension of the light-receiving side surface 14c. The pedestal portions 14f are separately provided on the light-emitting surface 14a of the sloping portion 14d.

The claw portions 14e are used for fixing the FPC 16 to its position.

The reflector 15 reflects light leaking out of the major surface 14b back to the light guide 14. The reflector 15 has flexibility and is provided on the surface opposite to the light-emitting surface 14a of the light guide 14.

The FPC 16 has flexibility. The FPC 16 has a thin rectangular shape. For example, the length of the longer dimension of the FPC 16 is substantially equal to the length of the light-receiving side surface 14c in the corresponding direction. The FPC 16 has two major surfaces, and the LEDs 30 are mounted on one of the major surfaces. The FPC 16 is an example of a substrate.

The sheet metal 17 is mainly made of, for example, aluminum. The sheet metal 17 is already curved in the direction of the longer dimension. The sheet metal 17 releases heat generated by the LEDs 30 and received via the FPC 16. In other words, the sheet metal 17 releases heat generated by the LEDs 30. The sheet metal 17 has flexibility and is provided on the other major surface of the FPC 16.

The procedure of the second step is described with reference to FIG. 5. In the second step, the lower surface of the double-sided adhesive tape 19 is bonded to the upper surface of the sheet metal 17, which is already curved as described above. The upper surface of the double-sided adhesive tape 19 is bonded to a surface of the FPC 16 opposite to the surface on which the LEDs 30 are mounted. With this procedure, the FPC 16 is fixed to the sheet metal 17 with the double-sided adhesive tape 19.

As illustrated in FIG. 5, the lower surface of the double-sided adhesive tape 18 is bonded to the upper surface of the sheet metal 17, and the upper surface of the double-sided adhesive tape 18 is bonded to the lower surface of the reflector 15. The double-sided adhesive tape 18 extends onto the FPC 16 and the lower surface of the double-sided adhesive tape 18 is bonded to a portion of the surface of the FPC 16 on which the LEDs 30 are mounted, the portion not being provided with the LEDs 30. The upper surface of the double-sided adhesive tape 18 is bonded to the major surface 14b of the light guide 14. As illustrated in FIG. 6, the upper surface of extending portions 18a of the double-sided adhesive tape 18 is bonded to the lower surface of the claw portions 14e. With the double-sided adhesive tape 18, the reflector 15 is fixed to the sheet metal 17 and the light guide 14 is fixed to the surface of the FPC 16 on which the LEDs 30 are mounted.

As described above, the double-sided adhesive tapes 18 and 19 integrate the light guide 14, the reflector 15, the FPC 16 on which the LEDs 30 are mounted, and the sheet metal 17. The integrated light guide 14, reflector 15, FPC 16 on which the LEDs 30 are mounted, and sheet metal 17 may be collectively referred to as a lighting module in the following description. The double-sided adhesive tapes 18 and 19 are an example of a fixing member.

As described above, the light guide 14 is fixed to the FPC 16 with the double-sided adhesive tape 18. In the present embodiment, the light guide 14 is fixed to the FPC 16 with the double-sided adhesive tape 18 such that the optical axis of an optical system provided at a side of the light guide 14 from which light is received substantially coincides with the optical axis of light emitted from the LEDs 30 mounted on the FPC 16. This configuration can prevent deviation of the optical axis of light emitted from the LEDs 30 mounted on the FPC 16 from the optical axis of the optical system provided at the side of the light guide 14 from which light is received.

In the present embodiment, the light guide 14 is fixed to the FPC 16 with the double-sided adhesive tape 18 such that each LED 30 is disposed between two adjacent claw portions 14e arranged in the direction of the longer dimension of the light-receiving side surface 14c.

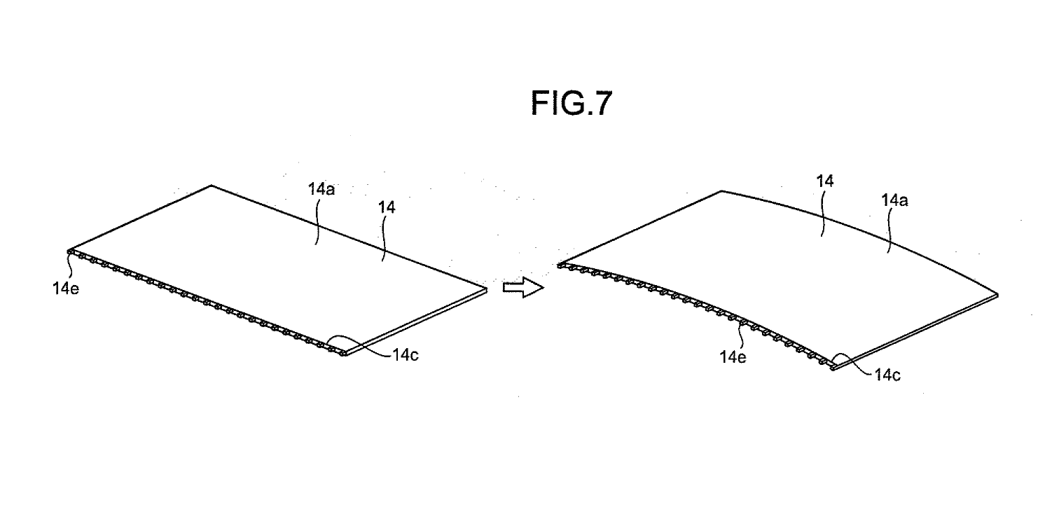

FIG. 7 is a diagram illustrating a change in form of the light guide 14. In the second step described above, the light guide 14 is fixed to the sheet metal 17, which is already curved, with the double-sided adhesive tapes 18 and 19, whereby the originally flat light guide 14 is curved in the direction of the longer dimension as illustrated in the example of FIG. 7.

In other words, in the present embodiment, the planar lighting device 10 having a fixed curved shape is manufactured by using a flat light guide 14 and curving the light guide 14, not by using an already curved light guide 14 that was curved in its production process. It is difficult to make a curved light guide by using a metal mold. It is also difficult to form a light redirecting pattern drawn by a plurality of dots on a curved light guide to give the light guide a certain optical characteristic. According to the present embodiment, the planar lighting device 10 having a fixed curved shape is manufactured by using a flat light guide 14 as described above, which facilitates the manufacturing of a fixed curved planar lighting device 10.

Third Step

In a third step, the lighting module assembled in the second step is sandwiched between the upper frame 11 and the lower frame 12 with the light emitting surface 14a of the light guide 14 in the lighting module being close to the optical sheet 13 and the sheet metal 17 of the lighting module being close to the lower frame 12, and then, the upper frame 11 and the lower frame 12 are joined together. The upper frame 11 and the lower frame 12 may be joined by using an adhesive, or may be joined by using screws, for example. Any known method can be used to join the upper frame 11 with the lower frame 12. The planar lighting device 10 is thus manufactured and finished.

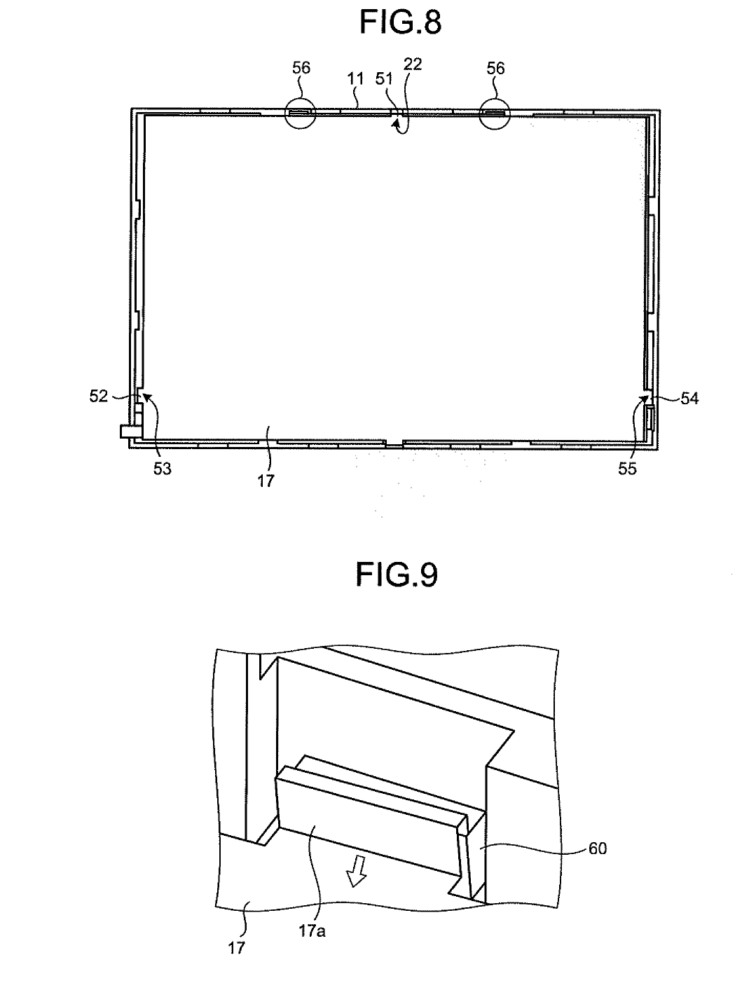

In the third step, the light guide 14, which is integrated with the sheet metal 17, is fixed relative to the upper frame 11 by fixing the sheet metal 17 to the upper frame 11. In other words, in the third step, the sheet metal 17 is positioned relative to the upper frame 11 and is fixed thereto. FIG. 8 is a diagram illustrating the third step of the method for manufacturing the planar lighting device 10 according to the embodiment. In the third step after the second step, as illustrated in the example of FIG. 8, for example, the sheet metal 17 has a protruding portion 51 disposed in a middle portion of the sheet metal 17 in the direction of the longer dimension. The protruding portion 51 protrudes in a direction orthogonal to the direction of the longer dimension of the sheet metal 17.

As illustrated in the example of FIG. 8, the upper frame 11 has the recessed portion 22 disposed in the middle portion of the upper frame 11 in the direction of the longer dimension. In the present embodiment, the protruding portion 51 can be engaged with the recessed portion 22. The protruding portion 51 of the sheet metal 17 is engaged with the recessed portion 22 of the upper frame 11, whereby the sheet metal 17 is positioned relative to the upper frame 11 in the direction of the longer dimension and is fixed thereto.

As illustrated in the example of FIG. 8, the sheet metal 17 has protruding portions 52 and 54 disposed in side portions of the sheet metal 17 close to the LEDs 30 in the direction of the shorter dimension. The protruding portions 52 and 54 protrude in the direction of the longer dimension of the sheet metal 17.

As illustrated in the example of FIG. 8, the upper frame 11 has recessed portions 53 and 55 disposed in side portions of the upper frame 11 close to the LEDs 30 in the direction of the shorter dimension. In the present embodiment, the protruding portion 52 can be engaged with the recessed portion 53, and the protruding portion 54 can be engaged with the recessed portion 55. The protruding portion 52 of the sheet metal 17 is engaged with the recessed portion 53 of the upper frame 11, and the protruding portion 54 of the sheet metal 17 is engaged with the recessed portion 55 of the upper frame 11, whereby the sheet metal 17 is positioned relative to the upper frame 11 in the direction of the shorter dimension and is fixed thereto.

When the sheet metal 17, which is positioned and fixed as described above, is used in a high temperature condition, the sheet metal 17 expands in directions from the center of the sheet metal 17 to both sides thereof in the direction of the longer dimension. When the sheet metal 17 is used in a low temperature condition, the sheet metal 17 shrinks in directions from both sides to the center of the sheet metal 17 in the direction of the longer dimension.

FIG. 9 is an enlarged view of a part 56 of the upper frame 11 illustrated in FIG. 8. As illustrated in the example of FIG. 9, the sheet metal 17 has a portion 17a formed by bending a part of an edge portion of the sheet metal 17, and the upper frame 11 is provided with an elastic member 60. In the third step, the position of the portion 17a of the sheet metal 17 relative to the elastic member 60 is adjusted such that the portion 17a is pushed by the elastic member 60 in the direction indicated by the arrow in FIG. 9. With this configuration, the sheet metal 17 is positioned relative to the upper frame 11 such that an edge of the sheet metal 17 abuts a surface of the upper frame 11 close to the LEDs 30, and is fixed thereto. The elastic member 60 may be a rubber or a spring, for example.

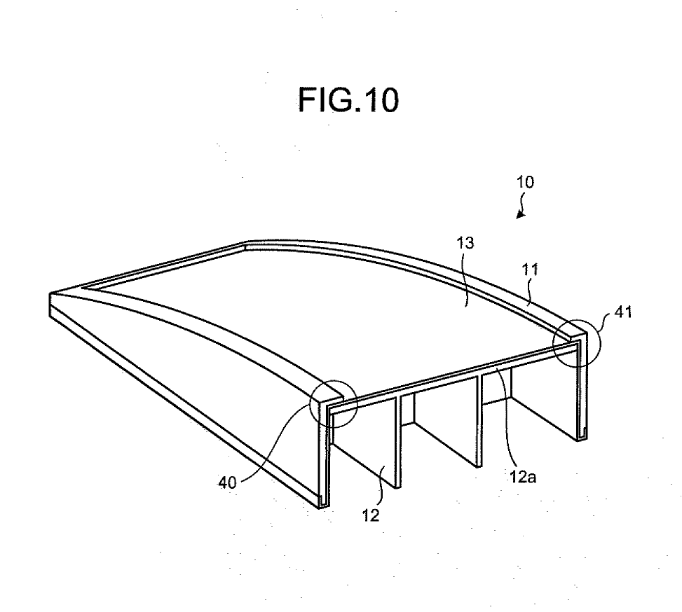

FIG. 10 is a cross-sectional view of the planar lighting device 10 assembled such that the upper frame 11 and the lower frame 12 are joined together with the lighting module being sandwiched therebetween. As illustrated in FIG. 10, the lower frame 12 has a curved surface 12a curving in the direction of the longer dimension thereof. The lighting module is sandwiched between the curved surface 12a and the upper frame 11, so that the lighting module is curved to have a curved shape. In the third step, the lighting module is sandwiched between the curved surface 12a and the upper frame 11 with the light-emitting surface 14a facing the aperture 11a. The lower frame 12 is an example of a second frame.

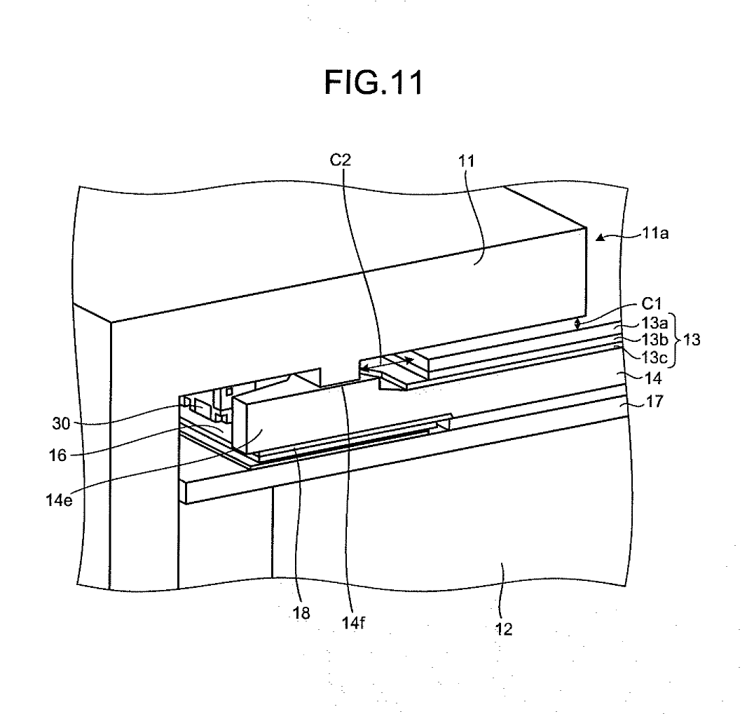

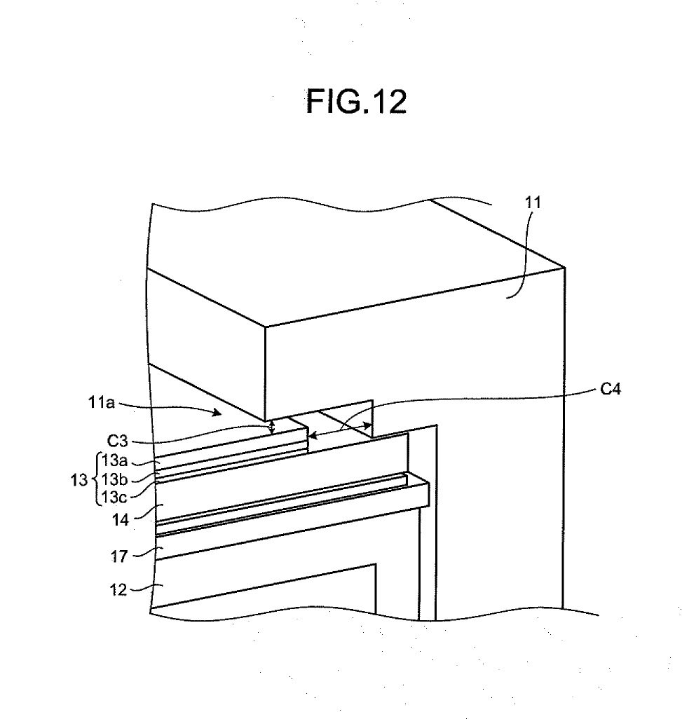

FIG. 11 is an enlarged view illustrating a part 40 of the planar lighting device 10 illustrated in FIG. 10. FIG. 12 is an enlarged view illustrating a part 41 of the planar lighting device 10 illustrated in FIG. 10.

As illustrated in the examples of FIGS. 11 and 12, the lighting module is sandwiched between the upper frame 11 and the lower frame 12 with the upper frame 11 only pushing the pedestal portions 14f to the lower frame 12. The upper frame 11 is configured not to push the optical sheet 13, and thus, vertical gaps C1 and C3 and horizontal gaps C2 and C4 are provided between the upper frame 11 and the optical sheet 13. As illustrated in FIGS. 11 and 12, the optical sheet 13 is a laminate of the optical sheets 13a, 13b, and 13c laminated in this order. The optical sheet 13 is disposed close to the light-emitting surface 14a. At least a part of an edge portion of the optical sheet 13 is disposed in a space defined by the upper frame 11 and the light guide 14 with the part being separated from the upper frame 11. The optical sheet 13 is curved along the light-emitting surface 14a of the curved light guide 14.

The upper frame 11 is configured not to push the optical sheet 13. This configuration can prevent corrugations that may form on the optical sheet 13 when the upper frame 11 pushes the optical sheet 13. This configuration can accordingly prevent the brightness variation on the screen of the liquid crystal display device using the planar lighting device 10 as the backlight.

The gaps C1 to C4 described above can also prevent the optical sheet 13 from being corrugated. If the optical sheet 13 expands, gaps between the optical sheet 13 and the upper frame 11 can prevent the optical sheet 13 from being corrugated, which may occur when the optical sheet 13 abuts the upper frame 11. This configuration can accordingly prevent the brightness variation on the screen of the liquid crystal display device using the planar lighting device 10 as the backlight.

The upper frame 11 is configured only to push the pedestal portions 14f disposed close to the light-receiving side surface 14c to the lower frame 12. Suppose that the light guide 14, the reflector 15, and the sheet metal 17 each have a different coefficient of thermal expansion and are deformed at a different curvature when the temperature changes significantly during use. In this case, the upper frame 11 only pushes portions of the light guide 14 close to the light-receiving side surface 14c, whereby the change in form of the light guide 14, the reflector 15, and the sheet metal 17 can be absorbed according to the present embodiment. This configuration can prevent corrugations on the optical sheet 13 that may occur due to a difference in coefficients of thermal expansion. This configuration can accordingly prevent the brightness variation on the screen of the liquid crystal display device using the planar lighting device 10 as the backlight.

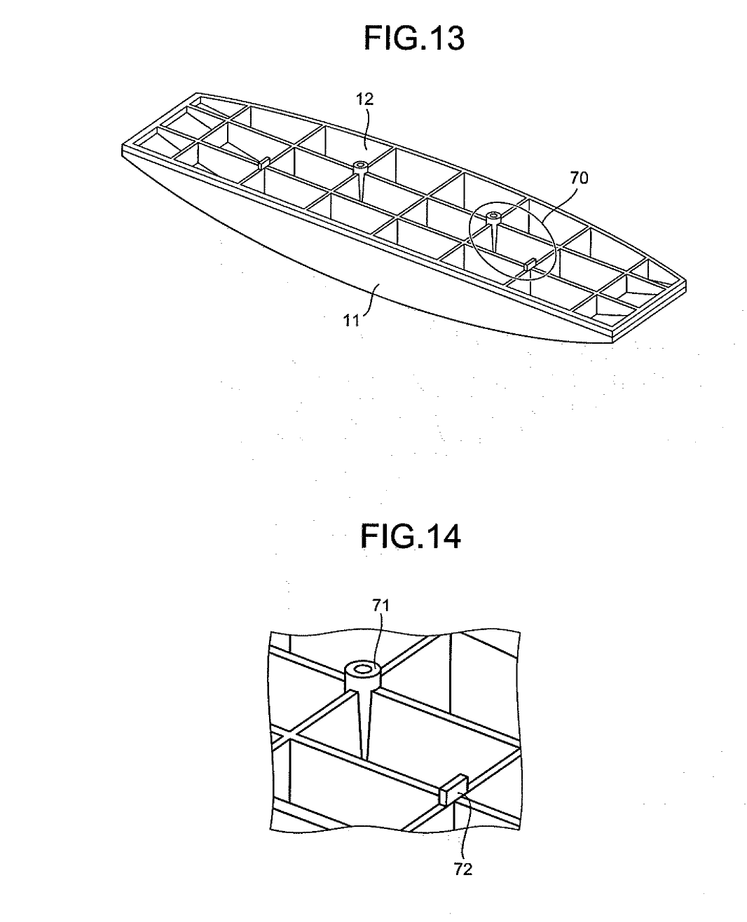

FIG. 13 is a perspective view illustrating the upper frame 11 and the lower frame 12 joined together in the third step. The upper frame 11 and the lower frame 12 are, for example, molded components made by die-casting or made of a resin. FIG. 14 is an enlarged view of a part 70 of the lower frame 12 illustrated in FIG. 13. The lower frame 12 is a molded component, and thus, a boss 71 and a wall 72 illustrated in FIG. 14 for attaching the lower frame 12 to a housing can easily be made in the molding process.

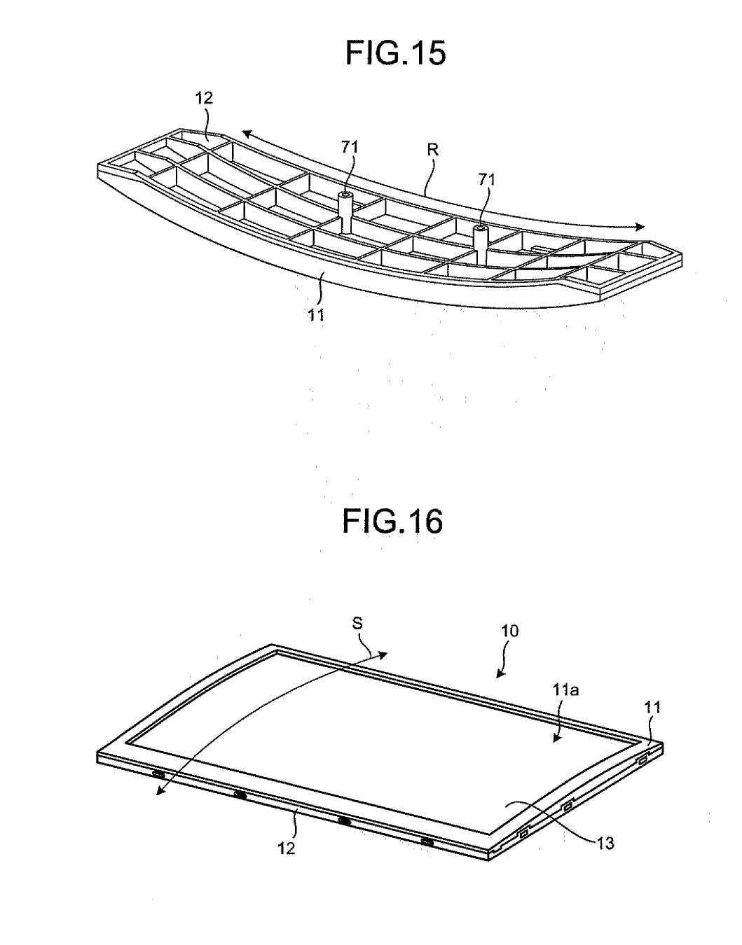

FIG. 15 is a perspective view illustrating another example of the upper frame 11 and the lower frame 12 joined together in the third step. As illustrated in the example of FIG. 15, the bottom surface of the lower frame 12 may be curved in the direction (indicated by an arrow R) of the longer dimension and bosses 71 and walls may be formed on the curved bottom surface.

The lower frame 12 may have a through hole through which heat from the LEDs 30 can be released without staying in the sheet metal 17. This configuration can increase efficiency in releasing heat by the sheet metal 17.

The planar lighting device 10 according to the embodiment has been described. According to the embodiment described above, brightness variation can be prevented.

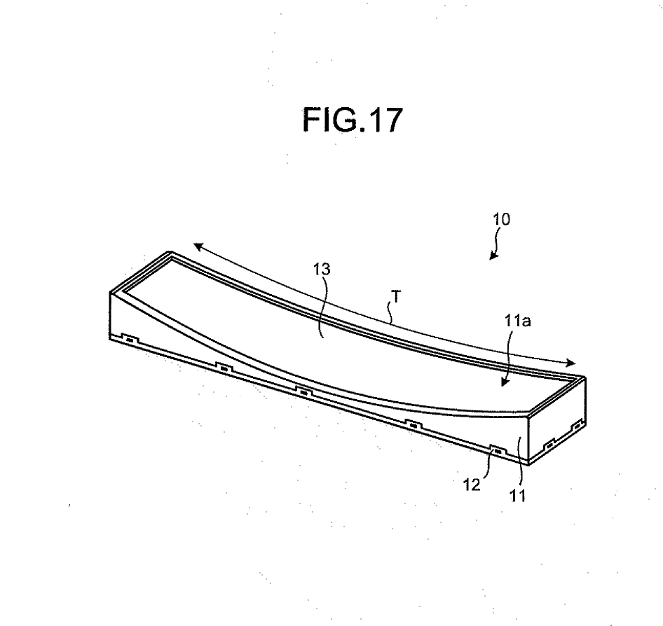

FIGS. 16 and 17 are diagrams each illustrating another example of the planar lighting device 10. The planar lighting device 10 according to the embodiment above has a shape of a convex curve curving in the direction of the longer dimension. However, the planar lighting device 10 may have a convex curve curving in the direction of the shorter dimension (indicated by an arrow S) as illustrated in FIG. 16. Alternatively, as illustrated in FIG. 17, the planar lighting device 10 may have a shape of a concave curve curving in the direction of the longer dimension (indicated by an arrow T). The planar lighting device 10 may have a concave curve curving in the direction of the shorter dimension.

According to the embodiment of the present invention, brightness variation can be prevented.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A planar lighting device comprising:
a light guide having flexibility and having side surfaces and a light-emitting surface, the light guide being configured to receive light from a side surface and emit the light from the light-emitting surface;
a light source disposed close to the side surface and configured to emit light that enters the side surface;
a first frame having a curved shape and having an aperture;
a second frame having a curved surface for sandwiching the light guide, the curved surface and the first frame sandwiching the light guide therebetween such that the light-emitting surface faces the aperture; and
an optical sheet disposed close to the light-emitting surface with at least a part of an edge portion of the optical sheet being disposed in a space defined by the first frame and the light guide, the part being separated from the first frame.

2. The planar lighting device according to claim 1, wherein
the light guide has a sloping portion and pedestal portions, the sloping portion sloping such that the light guide becomes less thick as the sloping portion extends from the side surface in a direction toward a side surface opposite to the side surface, the pedestal portions being separately provided on the light-emitting surface of the sloping portion, and
the first frame is configured to push the pedestal portions to the second frame.

3. The planar lighting device according to claim 1, wherein
the light guide is curved by being sandwiched between the first frame and the curved surface,
the optical sheet is curved along the light-emitting surface of the curved light guide and has a protruding portion disposed in a middle portion of the optical sheet in a direction in which the optical sheet is curving, the protruding portion protruding in a direction orthogonal to the direction in which the optical sheet is curving, and
the first frame has a recessed portion with which the protruding portion is engaged.

4. The planar lighting device according to claim 1, further comprising:
a substrate having flexibility and having first and second major surfaces, the light source being mounted on the first major surface;
a sheet metal having a curved shape, having flexibility, and provided on the second major surface of the substrate; and
a reflector having flexibility and provided on a surface opposite to the light-emitting surface of the light guide, wherein
the reflector is fixed to the sheet metal with a fixing member and the light guide is fixed to the substrate with the fixing member.

5. The planar lighting device according to claim 4, wherein the light guide is fixed to the substrate such that an optical axis of the light emitted by the light source coincides with an optical axis of an optical system provided at a side of the light guide from which the light is received.

6. The planar lighting device according to claim 4, further comprising an elastic member configured to push the sheet metal to the first frame.

7. The planar lighting device according to claim 4, wherein the second frame has a through hole.
